(19) United States
(12) Patent Application Publication
(10) Pub. No.: US 2005/0086383 A1
(43) Pub. Date: Apr. 21, 2005

(54) Optimizing the compression efficiency in a packet data communication

(75) Inventor: Khiem Le, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/757,455

(22) Filed: Jan. 15, 2004

Related U.S. Application Data
(60) Provisional application No. 60/511,661, filed on Oct. 17, 2003.

(51) Int. Cl. G06F 15/16

(52) U.S. Cl. 709/247

(57) ABSTRACT

A method of optimizing the compression efficiency in a packet data communication where a compression history of previous packets is used for the compression of a current packet, the method including: updating the compression history selectively, wherein the selection is performed based on a first algorithm whether a packet shall be compressed, and on a second algorithm whether a compressed packet shall be used for an update of the compression history. The compressor can be enabled to safely infer a subset of the context at the decompressor by simply monitoring the Transmission Control Protocol acknowledgment signaling, wherein that subset is used as a context for compression.

### CROSS-REFERENCE TO RELATED APPLICATIONS

This application claims priority of U.S. Provisional Application Ser. No. 60/511,661 entitled “Optimizing the Compression Efficiency in a Packet Data Communication,” filed Oct. 17, 2003, the entire contents of which are incorporated herein by reference.

### BACKGROUND OF THE INVENTION

The present invention relates to a method of optimizing the compression efficiency in a packet data communication where a compression history of previous packets is used for the compression of a current packet, as well as to a communication network and a compressing device and a decompressing device. The present invention has particular relevance in cellular communication systems.

### RELATED BACKGROUND ART

In present packet data communication systems, applications run over a reliable transport like the Transmission Control Protocol TCP, but over unreliable links like in cellular systems. The performance optimization of such applications is done through payload compression. A smaller payload means fewer bits to transmit over the bandwidth limited air interface, and therefore higher spectral efficiency and higher throughput, as seen by the end-user.

However, protocols running over TCP (e.g. hypertext transfer protocol—HTTP) often have a large payload, e.g. hundreds or thousands of bytes. An efficient payload compression will therefore provide significant benefits. Accordingly, there is a well-known method to boost the compression efficiency of a given data packet by using the content history of previous packets to compress the current packet.

Though, when packets can be lost between the compressor and decompressor (as is the case if e.g. there is a cellular link between the compressor and decompressor), the compressor and decompressor do not have the same view of the content history, which may lead to an incorrect decompression.

Existing approaches to address this history inconsistency issue are to mandate a reliable link between the compressor and decompressor, or to mandate a specific protocol between the compressor and decompressor to ensure history consistency.

### SUMMARY OF THE INVENTION

It is an object of the present invention to overcome the shortcomings of the prior art, and to provide an efficient and flexible method for optimizing the performance of an application by providing a compression with a selective history update.

The present invention is a method of optimizing the compression efficiency in a packet data communication where a compression history of previous packets is used for the compression of a current packet, the method comprising: updating the compression history selectively, wherein the selection is performed based on a first algorithm whether a packet shall be compressed, and on a second algorithm whether a compressed packet shall be used for an update of the compression history.

A history consistency between a compressor and a decompressor can be ensured by using the reliable nature of the Transmission Control Protocol, wherein the compressor monitors an acknowledgment signalling of a Transmission Control Protocol receiving means.

In this particular method, it is a further option that the compressor is enabled to safely infer a subset of the context at the decompressor by simply monitoring the Transmission Control Protocol acknowledgment signalling, wherein that subset is used as a context for compression.

Alternatively, in the method according to the present invention, a history consistency between a compressor and a decompressor can also be ensured by using a feedback between the compressor and the decompressor.

In addition, also the combination of these two measures is possible.

The present invention is also a method of optimizing the compression efficiency in a packet data communication where a compression history of previous packets. is used for the compression of a current packet, the method comprising: signalling by a compressing device to a decompressing device which packets are to be included in the compression history by using a first algorithm by the compressing device to decide if a packet should be compressed; using a second algorithm by the compressing device to decide which packets out of those packets sent compressed are to be used to update a buffer of the compressing device; signalling by a compressing device to a decompressing device such that the decompressing device knows which packets are to be included in the compression history; and using by the decompressing device a packet sequence number assigned by the compressor for updating a buffer thereof in synchronization with the compressing device.

Again, a history consistency between a compressor and a decompressor can be ensured according to one of the above described measures or according to the combination thereof.

In addition, it is again an option to enable the compressor to safely infer a subset of the context at the decompressor by simply monitoring the Transmission Control Protocol acknowledgment signalling, wherein that subset is used as a context for compression.

Further, the present invention is also a compression device for optimizing the compression efficiency in a packet data communication where a compression history of previous packets is used for the compression of a current packet, comprising: means for updating the compression history selectively, the means having implemented and processing a first algorithm related to whether a packet shall be compressed, and a second algorithm related to whether a compressed packet shall be used for an update of the compression history.

The compression device according to the present invention may further comprise means for monitoring an acknowledgment signalling of a Transmission Control Protocol receiving means.

As a further option, this particular compression device can be enabled to safely infer a subset of the context at the decompressor by simply monitoring the Transmission Control Protocol acknowledgment signalling, wherein that subset is used as a context for compression.

Alternatively, the compression device according to the present invention may further comprise means for establishing a feedback between the compression device and a decompression device.

Also a combination of the above described means is possible.

Still further, the present invention is a compression device for optimizing the compression efficiency in a packet data communication where a compression history of previous packets is used for the compression of a current packet, comprising: means for signalling to a decompression device which packets are to be included in the compression history by having implemented and processing a first algorithm to decide if a packet should be compressed; buffer means for storing the compression history; and means for having implemented and processing a second algorithm which packets out of those packets sent compressed are to be used to update the buffer means.

The compression device according to the present invention may further comprise means for monitoring an acknowledgment signalling of a Transmission Control Protocol receiving means.

As a further option, this particular compression device can be enabled to safely infer a subset of the context at the decompressor by simply monitoring the Transmission Control Protocol acknowledgment signalling, wherein that subset is used as a context for compression.

Alternatively, the compression device according to the present invention may further comprise means for establishing a feedback between the compression device and a decompression device.

Also a combination of the above described means is possible.

Moreover, the present invention is a decompression device for optimizing the compression efficiency in a packet data communication where a compression history of previous packets is used for the compression of a current packet, comprising: means for receiving signals from a compression device indicating which packets are to be included in the compression history; buffer means for storing the compression history; and means for processing a packet sequence number for updating the buffer means in synchronization with the compression device.

The decompression device according to the present invention can further comprise means for forwarding an acknowledgment signalling of a Transmission Control Protocol receiving means to the compression device.

Alternatively, the decompression device according to the present invention can further comprise means for establishing a feedback between the compression device and a decompression device.

In addition, also a combination of the above two means is possible.

According to the present invention, the compression ratio is boosted by compressing the payload of each packet using the content history of previous packets, instead of just the content of the packet being compressed. The correctness of the scheme can be ensured by using a compressor/decompressor feedback and/or the reliable nature of the Transmission Control Protocol TCP.

Further, since the compressor can decide which packet to include in the history, the present invention provides flexibility so that a more optimal memory usage can be made.

Besides, a reliable link is not required between the compressor and the decompressor to ensure history consistency.

A further advantage of the present invention is that it can be applied transparently to the application.

### BRIEF DESCRIPTION OF THE DRAWINGS

Hereinafter, further details, features and advantages of the present invention can be derived from the following description of the preferred embodiments thereof which is to be taken in conjunction with the accompanying drawings, in which:

FIG. 1 shows the case where the “TCP reliable nature” can be used; and

FIG. 2 shows the case where a “compressor-decompressor feedback” can be used.

### DETAILED DESCRIPTION OF THE PREFERRED EMBODIMENTS

Although the invention is applicable to any application transport protocol that is reliable, for the sake of explanation, the following description refers to a case where the application transport protocol is the Transport Control Protocol TCP as a preferred embodiment of the present invention. However, the present invention is in no way to be considered as being restricted thereto.

In the following, preferred embodiments of the present invention are described by making reference to the accompanying drawings.

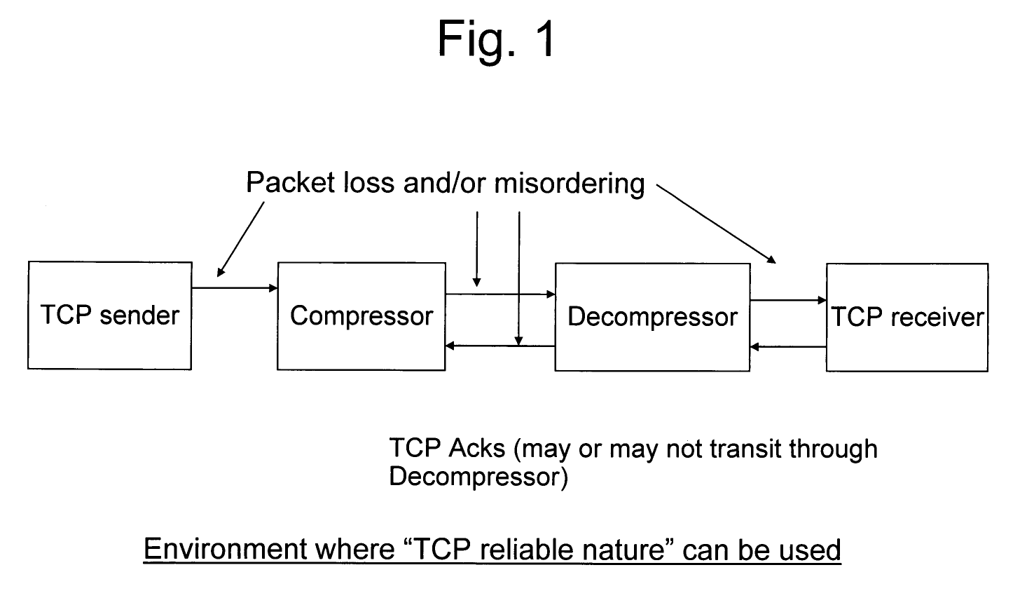

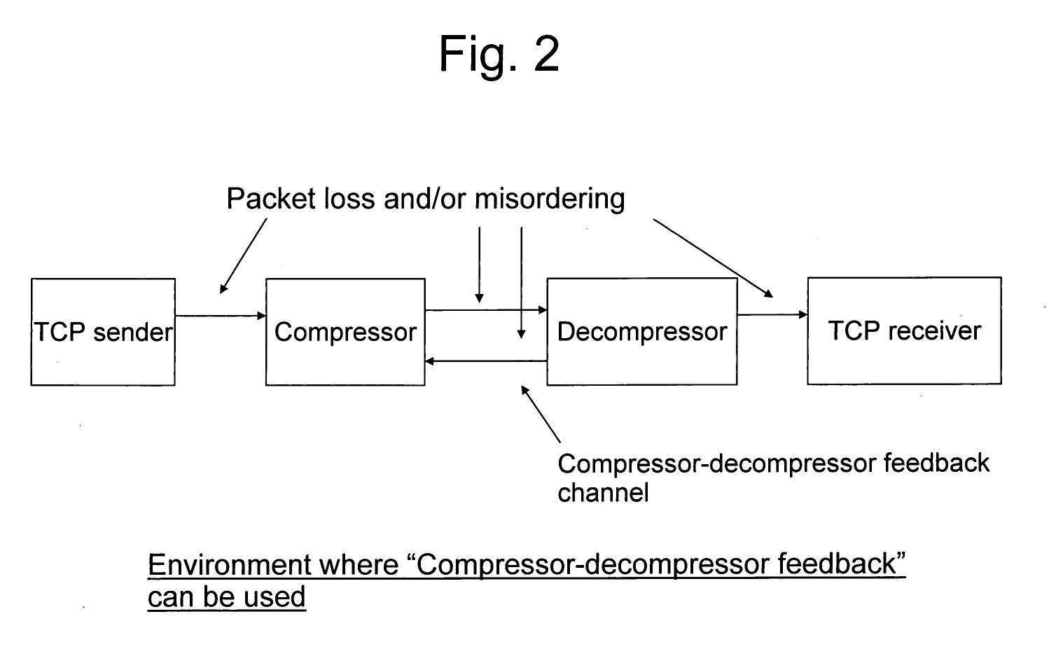

According to the above, in FIGS. 1 and 2, the application sender is a TCP sender and the application receiver is a TCP receiver. The compressor receives data from a TCP sender, compresses the payload and sends it to the decompressor. The decompressor decompresses the payload and forwards it to the TCP receiver. The paths between the different entities (TCP sender to compressor, compressor to decompressor and decompressor to TCP receiver) may include one or more unreliable links, where packets may be lost or misordered, as indicated in the figures. For the sake of explanation, it is assumed here that all the data from the TCP sender transits through the compressor. In a cellular system, for the downlink the compressor could be located at the GGSN (Gateway GPRS Support Node; GPRS: General Packet Radio Service) and the decompressor could be located at the mobile station, and for the uplink vice-versa.

According to the present invention, the compressor may decide not to include a packet which is not compressible, and therefore likely has low correlation with other future packets.

This flexibility results in a variety of options to ensure history consistency:

According to a preferred embodiment of the present invention, only the TCP reliable nature may be used. This case is depicted in FIG. 1. That is, the decompressor does not need to send a feedback to the compressor, while the compressor only needs to monitor the TCP acknowledgments. This can be used if there is no means for the decompressor to send a feedback to the compressor.

According to another preferred embodiment, only the compressor-decompressor feedback may be used, as depicted in FIG. 2. This can be useful if, for example, the TCP acknowledgments do not transit through the compressor, and therefore the compressor cannot rely on TCP to determine what data has been received.

Of course, according to a still further preferred embodiment of the present invention, the compressor-decompressor feedback can be used in combination with the TCP reliable nature. Actually, this provides the highest performance. It requires that the compressor can monitor the TCP acknowledgments, and that the decompressor can send a feedback to the compressor.

Details of implementation examples of the preferred embodiments of the present invention are described hereinafter. That is, the following description is to be understood as presenting examples for implementing the present invention, but is in no way intended to limit the scope of the present invention to the presented examples.

Overview of the Scheme

According to a preferred embodiment of the present invention, the compressor uses a first algorithm to decide if a packet should be compressed, i.e. if it should be sent compressed or uncompressed. Considerations include the compressibility of the packet, and/or CPU and memory limitations. As implementation examples, there can be a per-packet marking (explicit or implicit) to indicate to the decompressor whether the packet is compressed or not. The first algorithm and the marking scheme can be of any suitable form and are not described here in further detail. The compressor assigns a packet sequence number (PSN) to the packets which are sent compressed.

Out of the packets sent compressed, the compressor uses a second algorithm to decide which packets are used to update its buffer (C_buffer). As described above, also here might a per-packet marking (explicit or implicit) be used to indicate to the decompressor whether a packet updates the C_buffer or not. The decompressor relies on the PSN to update its buffer (D_buffer) in synchronism with the compressor. It shall be noted that, since the compressor decides what packets update the C_buffer, it has full flexibility how to handle a packet loss or misordering before the compressor. For example, a simple strategy could be to update the C_buffer with the packets in the order they arrive, regardless of any loss or misordering. In addition, the compressor can decide to selectively update, e.g. update the C_buffer only with those packets that are compressible.

Therefore, a packet loss or misordering before the compressor is not an issue.

However, what are issues to be addressed are any packet loss and misordering between the compressor and decompressor.

Terminology and Assumptions

C_buffer: Designates the buffer at the compressor containing some of the packets seen in the past. That buffer, or some subset of it, is used to compress along with possible static or user-specific data.

Size: designates the minimum of memory capacity allocated at the compressor and decompressor.

D_buffer: Designates the buffer at the decompressor containing some of the packets seen in the past. That buffer, or some subset of it, is used to decompress along with possible static or user-specific data.

In-sequence packet: Designates the case when the packet's PSN is equal to n, and packets with PSN (n−1), (n−2), etc. have been received.

Gap packet: Designates the case when the PSN is equal to (n+1), but there is a gap in the sequence of packet sequence numbers. For example, packets with packet sequence numbers (n−3), (n−2), (n−1) have been received, but not (n).

Single packet compression: Designates a compression using no data from previous packets. It shall be noted that the compressor may still use data previously agreed upon between the compressor and decompressor such as static data.

Highest_sent: Designates the PSN of the packet with the highest PSN sent so far by the compressor.

Highest_acked: Designates the PSN of the packet with the highest PSN known to be received by the decompressor. The knowledge can be based on monitoring the TCP acknowledgments (“acks”) and a correlation with the packet sequence numbers.

Compressor Logic

With respect to the processing logic for a new packet (not retransmitted by TCP nor by compressor), the compressor has the option to use the C-buffer to compress the packet. As described above, there can be a per-packet marking (explicit or implicit) to indicate to the decompressor that the C_buffer was used, however, any suitable marking scheme may be adopted.

Regarding the processing logic for a packet retransmitted by TCP, the compressor may use the subset of C-buffer, defined as consisting of the packets with PSN from (Highest_sent—size) to Highest_acked, to compress the packet. The packet does not update the C_buffer. Again, a per-packet marking (explicit or implicit) can serve to indicate to the decompressor that that subset of the C_buffer was used. It is to be noted that a packet retransmitted by the TCP sender may contain some new data.

Further, the processing logic when a “loss of packet n” (n is the PSN) notification from the decompressor is received is to resend a copy of packet n in the same format as the original transmission. That is, if packet n was originally transmitted compressed, it is retransmitted compressed, etc. The original PSN is used in this case. It is to be noted that this notification is received only when the compressor-decompressor feedback option is used (FIG. 2).

Concerning the processing logic when an “unable to decompress packet n” notification from the decompressor (n is the PSN) has been received, packet n is resent, but in a format that can be safely decompressed (e.g. single compression). In this case, the original PSN is used. There is an explicit or implicit marking to indicate to the decompressor that single compression is used. It is to be noted that this notification is received only when the compressor-decompressor feedback option is used (FIG. 2).

Decompressor Logic

The processing logic for an in-sequence packet can be to use the D_buffer to decompress, while the packet updates the D_buffer.

The processing logic for a gap packet, say with PSN (n+1), can be to store it temporarily. The decompressor waits for the missing packet for a short duration (in case packet n is not lost, but misordered). At time out, it will send a “loss of packet n” notification to the compressor. It is to be noted, that this notification is sent only when the compressor-decompressor feedback option is used (FIG. 2).

Further, the processing logic for a compressor-retransmitted packet can be that, when a previously missing packet is received, it is decompressed and the D_buffer is updated. If there is some gap packet that has become an in-sequence packet as a result of the D_buffer update, it is decompressed and the D_buffer is updated with that packet. The process is repeated until there is no more in-sequence packet.

Still further, the processing logic in case decompression is not possible is to discard the packet and to send an “unable to decompress packet n” notification. The decompressor may be unable to decompress due to a variety of reasons as e.g. an exceeded memory capacity.

For the latter case, however the following is to be noted in addition. If the decompressor has to store too many packets temporarily, while waiting for a missing packet, it may run out of memory. This problem can be mitigated by the following considerations. When the decompressor is integrated with the TCP stack (this is applicable to the case where the TCP receiver is in the mobile terminal, which is expected to be the most common one), the TCP stack would have to store the gap packets anyway, even if there were no compression/decompression. Further, the compressor can use a conservative approach and send only k outstanding packets compressed using C_buffer, where k is the capacity of the temporary storage at the decompressor. From the (k+1st) packet on, the compressor uses a safe compression, e.g. single packet compression, or the approach to compress a TCP retransmitted packet. Thus, the “Unable to decompress” notification would be the last resort mechanism.

Compressor/Decompressor Signaling

One example is that there is a per-packet marking to indicate to the decompressor the necessary information such as whether the packet is compressed, what buffer was used, etc.

### Other Embodiments

According to the preferred embodiments, the present invention can be implemented on terminals and network devices. It can be implemented as a built-in feature of GPRS so that the compression/decompression is done transparently to the application.

The present invention may also be implemented as being a part of methods related to header compression.

Experimental

By using the above described preferred embodiments of the present invention, experiments were made to observe how the compression ratio is boosted when using the content history of previous packets to compress the current packet (inter-packet compression), instead of just using the content of the current packet (single-packet compression). When applied to a typical Web page as for example http://www.americas.nokia.com/signals/, the bandwidth savings were boosted from 23% to 29% over all the packets, or from 50% to 60% over the compressible packets.

In detail, a comparison between inter-packet (ip) compression versus single-packet (sp) compression was made according to the following.

In the inter-packet mode the compression/decompression context is kept alive during the compression of 2124 packets while the single-packet mode resets the context after each packet. The ring buffer size in the experiment was set to 4 KB and the inter-packet performance was collected with a real implementation (i.e. not simulated by concatenating TCP segments).

The result showed the compression of 2124 packets, obtained over the Internet from http://www.americas.nokia.com/signals/, and there were 828 packet with no payload, which were taken out of the comparison. 475 of 1296 packets could be compressed either in single-packet or inter-packet mode. The comparison was done packet per packet.

The inter-packet mode had a better compression ratio in 453 cases where the gain ranged from 0.26 to 71.66%. Moreover, in 103 cases the ip mode could compress while the sp mode expanded the packets.

Thus, it could be concluded that the inter-packet compression resulted in better performance over the single-packet mode.

The results were:

Over All the Packets

single-packet:
   bandwidth saved=(1−1/1.299)=23.01771%
inter-packet:
   bandwidth saved=(1−1/1.41)=29.07801%
overall gain: absolute=29%−23%=6%,
   relative=(29%−23%)/23%=26%.
      Over the Compressible Packets
single-packet:
   bandwidth saved=(1−1/1.98)=49.49495%
inter-packet:
   bandwidth saved=(1−1/2.5)=60%
overall gain: absolute=60%−50%=10%,
   relative=(60%−50%)/50%=20%.

Thus, what is described above is a method of optimizing the compression efficiency in a packet data communication where a compression history of previous packets is used for the compression of a current packet, the method comprising: updating the compression history selectively, wherein the selection is performed based on a first algorithm whether a packet shall be compressed, and on a second algorithm whether a compressed packet shall be used for an update of the compression history.

While it is described above what is presently considered to be the preferred embodiments of the present invention, it is to be understood that the same is presented by way of example only, and that various modifications may be made without departing from the spirit and scope of the present invention as defined in the appended claims.

1. A method of optimizing the compression efficiency in a packet data communication where a compression history of previous packets is used for the compression of a current packet, the method comprising:
updating the compression history selectively, wherein selection is performed based on a first algorithm for determining whether a packet shall be compressed, and on a second algorithm for determining whether a compressed packet shall be used for an update of the compression history.

2. The method according to claim 1, further comprising:
ensuring a history consistency between a compressor and a decompressor is by using Transmission Control Protocol, wherein the compressor monitors an acknowledgment signaling of a Transmission Control Protocol receiving means.

3. The method according to claim 1, further comprising:
ensuring a history consistency between a compressor and a decompressor by using a feedback between the compressor and the decompressor.

4. The method according to claim 2, further comprising:
enabling the compressor to safely infer a subset of a first context at the decompressor by monitoring the Transmission Control Protocol acknowledgment signaling, wherein the subset is used as a second context for compression.

5. The method according to claim 1, further comprising:
ensuring a history consistency between a compressor and a decompressor by combining use of Transmission Control Protocol, wherein the compressor monitors an acknowledgment signaling of a Transmission Control Protocol receiving means, with use of a feedback between the compressor and the decompressor.

6. A method of optimizing compression efficiency in a packet data communication where a compression history of previous packets is used for compression of a current packet, the method comprising:
using a first algorithm in conjunction with a compressing device to decide if the current packet should be compressed;
using a second algorithm in conjunction with the compressing device to decide which packets out of packets sent compressed are to be used to update a buffer of the compressing device;
signaling from the compressing device to a decompressing device such that the decompressing device knows which of the packets out of the packets sent are to be included in the compression history; and
using the decompressing device and a packet sequence number assigned by a compressor to update a buffer thereof in synchronization with the compressing device.

7. The method according to claim 6, further comprising:
ensuring a history consistency between the compressing device and the decompressing device by using Transmission Control Protocol, wherein the compressing device monitors an acknowledgment signaling of a Transmission Control Protocol receiving means.

8. The method according to claim 7, further comprising:
enabling the compressing device to safely infer a subset of a first context at the decompressing device by monitoring the Transmission Control Protocol acknowledgment signaling, wherein the subset is used as a second context for compression.

9. The method according to claim 6, further comprising:
ensuring a history consistency between the compressing device and the decompressing device by using a feedback between the compressing device and the decompressing device.

10. The method according to claim 6, further comprising:
ensuring a history consistency between the compressing device and the decompressing device by combining use of Transmission Control Protocol, wherein the compressing device monitors an acknowledgment signaling of a Transmission Control Protocol receiving means, with use of a feedback between the compressing device and the decompressing device.

11. A compression device for optimizing compression efficiency in a packet data communication where a compression history of previous packets is used for compression of a current packet, the device comprising:
updating means for updating the compression history selectively, the updating means having implemented and processing a first algorithm related to whether a packet shall be compressed, and a second algorithm related to whether a compressed packet shall be used for an update of the compression history; and
storing means, operably connected to the updating means, for storing the compression history.

12. The device according to claim 11, further comprising monitoring means for monitoring an acknowledgment signaling of a Transmission Control Protocol receiving means, wherein the monitoring means is operably connected to the updating means.

13. The device according to claim 12, wherein said monitoring means is adapted to be enabled to safely infer a subset of a first context at a decompressor by monitoring Transmission Control Protocol acknowledgment signaling, wherein the subset is used as a second context for compression.

14. The device according to claim 11, further comprising establishing means for establishing a feedback between the compression device and a decompression device, wherein the establishing means is operably connected to the updating means.

15. A compression device for optimizing compression efficiency in a packet data communication where a compression history of previous packets is used for compression of a current packet, the device comprising:
signaling means for signaling to a decompression device which of a first set of packets are to be included in the compression history, the signaling means having implemented and processing a first algorithm used to decide if the current packet should be compressed;
buffer means, operably connected to the signaling means, for storing the compression history; and
processing means for having implemented and processing a second algorithm, wherein the second algorithm is used to determine which of a second set of packets out of a third set of packets sent compressed are to be used to update the buffer means, wherein the processing means is operably connected to the signaling means.

16. The device according to claim 15, further comprising means for monitoring an acknowledgment signaling of a Transmission Control Protocol receiving means, wherein the monitoring means is operably connected to the signaling means.

17. The device according to claim 16, wherein the monitoring means is adapted to be enabled to safely infer a subset of a first context at a decompressor by monitoring a Transmission Control Protocol acknowledgment signaling, wherein the subset is used as a second context for compression.

18. The device according to claim 15, further comprising establishing means for establishing a feedback between the compression device and a decompression device, wherein the establishing means is operably connected to the signaling means.

19. A decompression device for optimizing compression efficiency in a packet data communication where a compression history of previous packets is used for compression of a current packet, the device comprising:
receiving means for receiving signals from a compression device indicating which packets are to be included in the compression history;
buffer means, operably connected to the receiving means, for storing the compression history; and
processing means for processing a packet sequence number for updating the buffer means in synchronization with the compression device, wherein the processing means is operably connected to the receiving means.

20. The device according to claim 19, further comprising forwarding means for forwarding an acknowledgment signaling of a Transmission Control Protocol receiving means to the compression device, wherein the forwarding means is operably connected to the receiving means.

21. The device according to claim 19, further comprising establishing means for establishing a feedback between the compression device and the decompression device, wherein the establishing means is operably connected to the receiving means.

22. A compression device for optimizing compression efficiency in a packet data communication where a compression history of previous packets is used for compression of a current packet, the device comprising:
a processor configured to allow for updating the compression history selectively, the processor having implemented and processing a first algorithm related to whether a packet shall be compressed, and a second algorithm related to whether a compressed packet shall be used for an update of the compression history; and
a memory unit, operably connected to the processor, for storing the compression history.

23. A compression device for optimizing compression efficiency in a packet data communication where a compression history of previous packets is used for compression of a current packet, the device comprising:
a signaling unit configured to signal a decompression device which of a first set of packets are to be included in the compression history, the signaling unit having implemented and processing a first algorithm used to decide if the current packet should be compressed;
a buffer, operably connected to the signaling unit, configured to store the compression history; and
a processor configured to have implemented and to process a second algorithm, wherein the second algorithm is used to determine which of a second set of packets out of a third set of packets sent compressed are to be used to update the buffer, wherein processor is operably connected to the means for signaling.

24. A decompression device for optimizing compression efficiency in a packet data communication where a compression history of previous packets is used for compression of a current packet, the device comprising:
a receiver configured to receive signals from a compression device indicating which packets are to be included in the compression history;
a buffer, operably connected to the receiver, configured to store the compression history; and
a processor configured to process a packet sequence number for updating the buffer in synchronization with the compression device, wherein the processor is operably connected to the receiver.
